(19) United States
(12) Patent Application Publication
(10) Pub. No.: US 2024/0232420 A9
(43) Pub. Date: Jul. 11, 2024

(54) SYSTEM AND METHOD OF DYNAMIC SEARCH RESULT PERMISSION CHECKING

(71) Applicant: SHINYDOCS CORPORATION, Kitchener (CA)

(72) Inventors: Jason William David CASSIDY, Kitchener (CA); Khalid MERHI, Kitchener (CA); Mark KRAATZ, Waterloo (CA); Robert HASKETT, Kitchener (CA); Benjamin BARTH, Waterloo (CA); Darryl MCCUTCHEON, Wellesley (CA); Gorgi TERZIEV, Strumica (MK); Jesse SHEATHER, Baden (CA); Davey SLIMMON, Ottawa (CA); Peter VANLEEUWEN, Guelph (CA); Scott WOODEND, Kitchener (CA)

(21) Appl. No.: 18/490,071

(22) Filed: Oct. 19, 2023

Related U.S. Application Data
(60) Provisional application No. 63/418,016, filed on Oct. 20, 2022.

(51) Int. Cl. G06F 21/62; G06F 21/31

(52) U.S. Cl. CPC G06F 21/6227; G06F 21/31

(57) ABSTRACT

A system and method of dynamic search result permission checking. A system that provides end users the ability to search an index (i.e., Shinydocs Index) built from content from one or multiple source repositories, and only display results for which the user has sufficient permissions at source to view. User credentials are validated “on the fly”, such that these checks are performant across a multiple of possible back-end repositories sequentially or simultaneously. The resultant search results from the Index may be sourced from many disparate repositories, each of which have their own unique permission structure (to view individual items). A method for handling permissions in multiple repositories in a secure (yet performant) fashion in order to only display search results that the end-user is allowed to view based on source system permissions.

### CROSS REFERENCE TO RELATED APPLICATION

This application claims priority to and the benefit of U.S. Provisional Patent Application Ser. No. 63/418,016, entitled “SYSTEM AND METHOD OF DYNAMIC SEARCH RESULT PERMISSION CHECKING”, filed on Oct. 20, 2022, the disclosure of which is incorporated herein by reference in its entirety.

### FIELD

This disclosure relates to computer systems and, more specifically, to remote file storage and access.

### BACKGROUND

Content management systems or enterprise content management systems are often used to store files and other data for access by users of an organization's computers.

Since the start of the digital revolution, organizations have been creating digital content at an accelerating pace without considering how to find, manage and action all these unstructured documents. At a mid-sized company, this can amount to hundreds of terabytes (TB) of data (which corresponds to hundreds of millions of documents). At a large-sized company this can amount to petabytes (PB) of data (each petabyte corresponds to about a billion documents).

This digital content (mainly documents) for an organization may exist in many disparate repositories: file shares, ECMs such as Microsoft SharePoint Online, IBM FileNet, OpenText Content Server, BOX, or even in an email platform like Microsoft Exchange (as document attachments). Building a unified Index of the documents contained in all of these repositories is possible with Shinydocs' Cognitive Toolkit product. However, granting access to information in this Index to anyone other than an Administrator is a challenge. When repositories are crawled and their information added to the Index, this is usually done with Administrator permissions. Therefore, the number of documents crawled and indexed is typically MUCH greater than what a given end-user should have access to, since the crawl was performed at a permission level of a System Administrator, enabling access to all documents.

Controlling a named end-user's ability to view information in the Index needs to be limited to those documents that the named end-user could normally access in each origin repository (i.e. the information such a user ought to be able to see in an Index of that data should be no more than what they could see in each source repository itself).

Therefore, there is a need to have accurate and relevant document source permissions respected when Index search results are displayed.

Building an Index-level cache or “mapping” of user permissions based on those that exist for each source repository/document may seem like a viable solution for this problem, however:
Permissions on documents in some repositories are very difficult (sometimes impossible) to exactly model in a system external to that repository.
Any permissions that are cached may no longer be valid at the time of searching, with the likelihood of this increasing as the age of the permission cache increases. For example, a user in the Finance department may have access to thousands of finance documents, but may have been transferred to another department, such as Marketing. If access to Finance documents is updated on a file share to remove that users access, but the permission cache has not been updated, that user would continue to have access to those Finance documents until the permission cache is updated. Conversely, that user may not have access to Marketing documents at all until the permission cache is updated.

In summary, the fundamental problem to be addressed is how to ensure a given user may only have search access to documents in the Index that aligns with their current level of permissions in every source repository referenced in the Index, without a requirement to cache all document permissions externally to the original repositories.

There is a desire to provide a tool that provides improved permission checking with the greatest level of accuracy and relevance possible.

### SUMMARY

A system and method of dynamic search result permission checking. A system that provides end users the ability to search an index (i.e., Shinydocs Index) built from content from one or multiple source repositories, and only display results for which the user has sufficient permissions at source to view. User credentials are validated “on the fly”, such that these checks are performed across a multiple of possible back-end repositories sequentially or simultaneously. The resultant search results from the Index may be sourced from many disparate repositories, each of which have their own unique permission structure (to view individual items). A method for handling permissions in multiple repositories in a secure (yet performant) fashion in order to only display search results that the end-user is allowed to view based on source system permissions.

### BRIEF DESCRIPTION OF THE DRAWINGS

The drawings illustrate, by way of example only, embodiments of the present disclosure.

FIG. 1 is a block diagram of a networked computer system.

FIG. 2 is a block diagram of a user computer device.

FIG. 3 is a schematic diagram illustrating architecture for file shares.

FIG. 4 is a schematic diagram illustrating architecture for content server.

FIG. 5 is a flow diagram illustrating a dynamic search result permission checking process.

FIGS. 6A and 6B are exemplary embodiments of a Discover Search Frontend Graphical User Interface (GUI).

### DETAILED DESCRIPTION

This disclosure concerns exposing a remote content management system to a server running the Shinydocs Cognitive Suite. Shinydocs Cognitive Suite is a content management interface system. Information will be transferred from the remote content management system to the Cognitive Suite, which will then be embellished using various automated methods to assign attributes to each of these documents (in the Cognitive Suite).

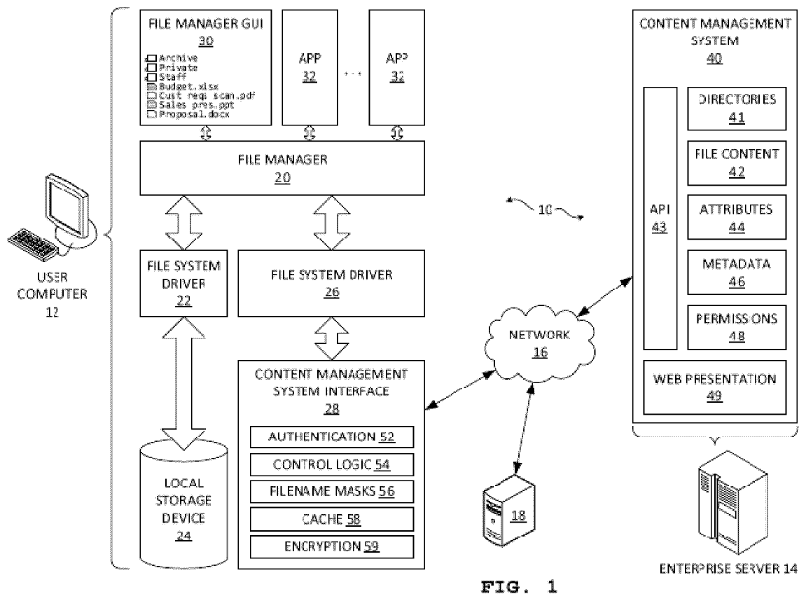

FIG. 1 shows a networked computer system 10 according to the present invention. The system 10 includes at least one user computer device 12 and at least one server 14 connected by a network 16.

The user computer device 12 can be any computing device such as a desktop or notebook computer, a smartphone, tablet computer, and the like. The user computer device 12 may be referred to as a computer.

The server 14 is a device such as a mainframe computer, blade server, rack server, cloud server, or the like. The server 14 may be operated by a company, government, or other organization and may be referred to as an enterprise server or an enterprise content management (ECM) system.

The network 16 can include any combination of wired and/or wireless networks, such as a private network, a public network, the Internet, an intranet, a mobile operator's network, a local-area network, a virtual-private network (VPN), and similar. The network 16 operates to communicatively couple the computer device 12 and the server 14.

In a contemplated implementation, a multitude of computer devices 12 connect to several servers 14 via an organization's internal network 16. In such a scenario, the servers 14 store documents and other content in a manner that allows collaboration between users of the computer devices 12, while controlling access to and retention of the content. Such an implementation allows large, and often geographically diverse, organizations to function. Document versioning or/and retention may be required by some organizations to meet legal or other requirements.

The system 10 may further include one or more support servers 18 connected to the network 16 to provide support services to the user computer device 12. Examples of support services include storage of configuration files, authentication, and similar. The support server 18 can be within a domain controlled by the organization that controls the servers 14 or it can be controlled by a different entity.

The computer device 12 executes a file manager 20, a local-storage file system driver 22, a local storage device 24, a remote-storage file system driver 26, and a content management system interface 28.

The file manager 20 is configured for receiving user file commands from a user interface (e.g., mouse, keyboard, touch screen, etc.) and outputting user file information via the user interface (e.g., display). The file manager 20 may include a graphical user interface (GUI) 30 to allow a user of the computer 12 to navigate and manipulate hierarchies of folders and files, such as those residing on the local storage device 24. Examples of such include Windows® Internet Explorer and macOS® Finder. The file manager 20 may further include an application programming interface (API) exposed to one or more applications 32 executed on the computer 12 to allow such applications 32 to issue commands to read and write files and folders. Generally, user file commands include any user action (e.g., user saves a document) or automatic action (e.g., application's auto-save feature) performed via the file manager GUI 30 or application 32 that results in access to a file. The file manager GUI 30 and API may be provided by separate programs or processes. For the purposes of this disclosure, the file manager 20 can be considered to be one or more processes and/or programs that provide one or both of the file manager GUI 30 and the API.

The local-storage file system driver 22 is resident on the computer 12 and provides for access to the local storage device. The file system driver 22 responds to user file commands, such as create, open, read, write, and close, to perform such actions on files and folders stored on the local storage device 24. The file system driver 22 may further provide information about files and folders stored on the local storage device 24 in response to requests for such information.

The local storage device 24 can include one or more devices such as magnetic hard disk drive, optical drives, solid-state memory (e.g., flash memory), and similar.

The remote-storage file system driver 26 is coupled to the file manager 20 and is further coupled to the content management system interface 28. The file system driver 26 maps the content management system interface 28 as a local drive for access by the file manager 20. For example, the file system driver 26 may assign a drive letter (e.g., “H:”) or mount point (e.g., “/Enterprise”) to the content management system interface 28. The file system driver 26 is configured to receive user file commands from the file manager 20 and output user file information to the file manager 20. Examples of user file commands include create, open, read, write, and close, and examples of file information include file content, attributes, metadata, and permissions. The remote-storage file system driver 26 can be based on a user-mode file system driver.

The remote-storage file system driver 26 can be configured to delegate callback commands to the content management system interface 28. The callback commands can include file system commands such as Open, Close, Cleanup, CreateDirectory, OpenDirectory, Read, Write, Flush, GetFileInformation, GetAttributes, FindFiles, SetEndOfFile, SetAttributes, GetFileTime, SetFileTime, LockFile, UnLockFile, GetDiskFreeSpace, GetFileSecurity, and SetFileSecurity.

The content management system interface 28 is the interface between the computer 12 and the enterprise server 14. The content management system interface 28 connects, via the network 16, to a content management system 40 hosted on the enterprise server 14. As will be discussed later in this document, the content management system interface 28 can be configured to translate user commands received from the driver 26 into content management commands for the remote content management system 40.

The content management system interface 28 is a user-mode application that is configured to receive user file commands from the file manager 20, via the driver 26, and translate the user file commands into content management commands for sending to the remote content management system 40. The content management system interface 28 is further configured to receive remote file information from the remote content management system 40 and to translate the remote file information into user file information for providing to the file manager 20 via the driver 26.

The remote content management system 40 can be configured to expose an API 43 to the content management system interface 28 in order to exchange commands, content, and other information with the content management system interface 28. The remote content management system 40 stores directory structures 41 containing files in the form of file content 42, attributes 44, metadata 46, and permissions 48. File content 42 may include information according to one or more file formats (e.g., “.docx”, “.txt”, “.dxf”, etc.), executable instructions (e.g., an “.exe” file), or similar. File attributes 44 can include settings such as hidden, read-only, and similar. Metadata 46 can include information such as author, date created, date modified, tags, file size, and similar. Permissions 48 can associate user or group identities to specific commands permitted (or restricted) for specific files, such as read, write, delete, and similar.

The remote content management system 40 can further include a web presentation module 49 configured to output one or more web pages for accessing and modifying directory structures 41, file content 42, attributes 44, metadata 46, and permissions 48. Such web pages may be accessible using a computer's web browser via the network 16.

The content management system interface 28 provides functionality that can be implemented as one or more programs or other executable elements. The functionality will be described in terms of distinct elements, but this is not to be taken as limiting. In specific implementations, not all of the functionality needs to be implemented.

The content management system interface 28 includes an authentication component 52 that is configured to prompt a user to provide credentials for access to the content management system interface 28 and for access to the remote content management system 40. Authentication may be implemented as a username and password combination, a certificate, or similar, and may include querying the enterprise server 14 or the support server 18. Once the user of the computer device 12 is authenticated, he or she may access the other functionality of the content management system interface 28.

The content management system interface 28 includes control logic 54 configured to transfer file content between the computer 12 and the server 14, apply filename masks, evaluate file permissions and restrict access to files, modify file attributes and metadata, and control the general operation of the content management system interface 28. The control logic 54 further affects mapping of remote paths located at the remote content management system 40 to local paths presentable at the file manager 20. Path mapping permits the user to select a file via the final manager 20 and have file information and/or content delivered from the remote content management system 40. In one example, the remote files and directories are based on a root path of “hostname/directory/subdirectory” that is mapped to a local drive letter or mount point and directory (e.g., “H:/hostname/directory/subdirectory”).

The content management system interface 28 includes filename masks 56 that discriminate between files that are to remain local to the computer 12 and files that are to be transferred to the remote content management system 40. Temporary files may remain local, while master files that are based on such temporary files may be sent to the remote content management system 40. This advantageously prevents the transmission of temporary files to the remote content management system 40, thereby saving network bandwidth and avoiding data integrity issues (e.g., uncertainty and clutter) at the remote content management system 40.

The content management system interface 28 includes a cache 58 of temporary files, which may include working versions of files undergoing editing at the user computer device 12 or temporary files generated during a save or other operating of an application 32.

The content management system interface 28 includes an encryption engine 59 configured to encrypt at least the cache 58. The encryption engine 59 can be controlled by the authentication component 52, such that a log-out or time out triggers encryption of the cache 58 and successful authentication triggers decryption of the cache 58. Other informational components of the content management system interface 28 may be encrypted as well, such as the filename masks 56. The encryption engine 59 may conform to an Advanced Encryption Standard (AES) or similar.

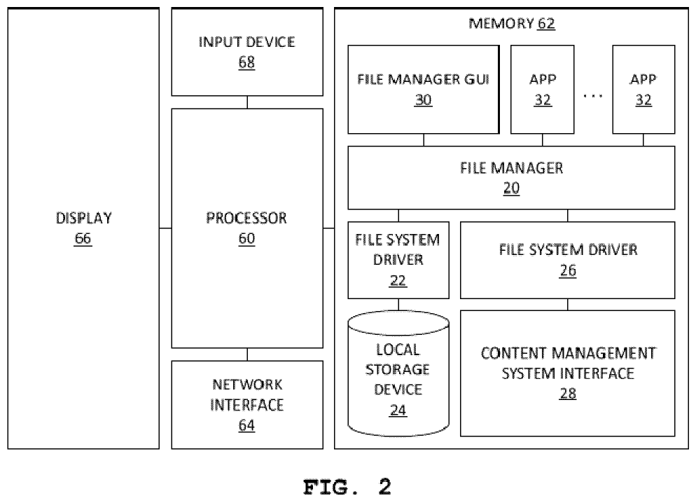

FIG. 2 shows an example of a user computer device 12. The computer device 12 includes a processor 60, memory 62, a network interface 64, a display 66, and an input device 68. The processor 60, memory 62, network interface 64, display 66, and input device 68 are electrically interconnected and can be physically contained within a housing or frame.

The processor 60 is configured to execute instructions, which may originate from the memory 62 or the network interface 64. The processor 60 may be known as CPU. The processor 60 can include one or more processors or processing cores.

The memory 62 includes a non-transitory computer-readable medium that is configured to store programs and data. The memory 62 can include one or more short-term or long-term storage devices, such as a solid-state memory chip (e.g., DRAM, ROM, non-volatile flash memory), a hard drive, an optical storage disc, and similar. The memory 62 can include fixed components that are not physically removable from the client computer (e.g., fixed hard drives) as well as removable components (e.g., removable memory cards). The memory 62 allows for random access, in that programs and data may be both read and written.

The network interface 64 is configured to allow the user computer device 12 to communicate with the network 16 (FIG. 1). The network interface 64 can include one or more of a wired and wireless network adaptor as well as a software or firmware driver for controlling such adaptor.

The display 66 and input device 68 form a user interface that may collectively include a monitor, a screen, a keyboard, keypad, mouse, touch-sensitive element of a touch-screen display, or similar device.

The memory 62 stores the file manager 20, the file system driver 26, and the content management system interface 28, as well as other components discussed with respect to FIG. 1. Various components or portions thereof may be stored remotely, such as at a server. However, for purposes of this description, the various components are locally stored at the computer device 12. Specifically, it may be advantageous to store and execute the file manager 20, the file system driver 26, and the content management system interface 28 at the user computer device 12, in that a user may work offline when not connected to the network 16. In addition, reduced latency may be achieved. Moreover, the user may benefit from the familiar user experience of the local file manager 20, as opposed to a remote interface or an interface that attempts to mimic a file manager.

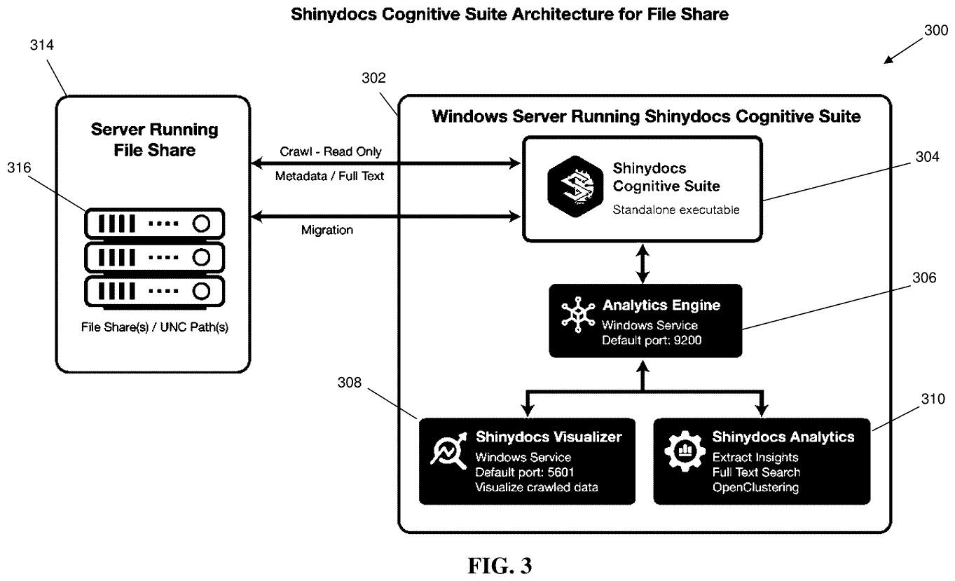

FIG. 3 is a schematic diagram illustrating architecture for file shares. According to FIG. 3, a separate server 314 is shown running File Shares 316 and interacts with a Windows Server running Shinydocs Cognitive Suite 302. The File Shares 316, or Enterprise Content Management systems, content sources or file shares contain files of various sizes, many of which contain text. The Shinydocs Cognitive Suite 304 (as a component of Windows Server running Shinydocs Cognitive Suite 302) can be a standalone executable that extracts metadata from these file shares which are stored in the Analytics Engine 306. The Shinydocs Cognitive Suite 304 likewise extracts text from files in these file shares, which are also stored in the Analytics Engine 306.

According to FIG. 3, Analytics Engine 306 can programmatically break apart large chunks of text when doing text extraction and will likewise logically recombine those large chunks of text for operations such as searching for strings of text that are contained in the extracted text.

The Analytics Engine 306 described in FIG. 3 is part of the Shinydocs Cognitive Suite 302 and interfaces with the Shinydocs Visualizer 308 and Shinydocs Analytics 310 components (or modules). The Shinydocs Visualizer module 308 enables visualization of crawled data and enables a windows service to connect to a default port (e.g., port 5601). The Shinydocs Analytics module 310 is configured to extract insights, perform full text searches and perform open clustering.

According to FIG. 3, the Analytics Engine 306 also leverages open-source search applications (such as Elasticsearch or Open Search) as the underlying technology. In this description, Elasticsearch is referenced as the search engine, but is interchangeable with other similar open-source search engines. Furthermore, Analytics Engine 306 is also configured as a Windows Service enabling connection to a default port (e.g., port 9200).

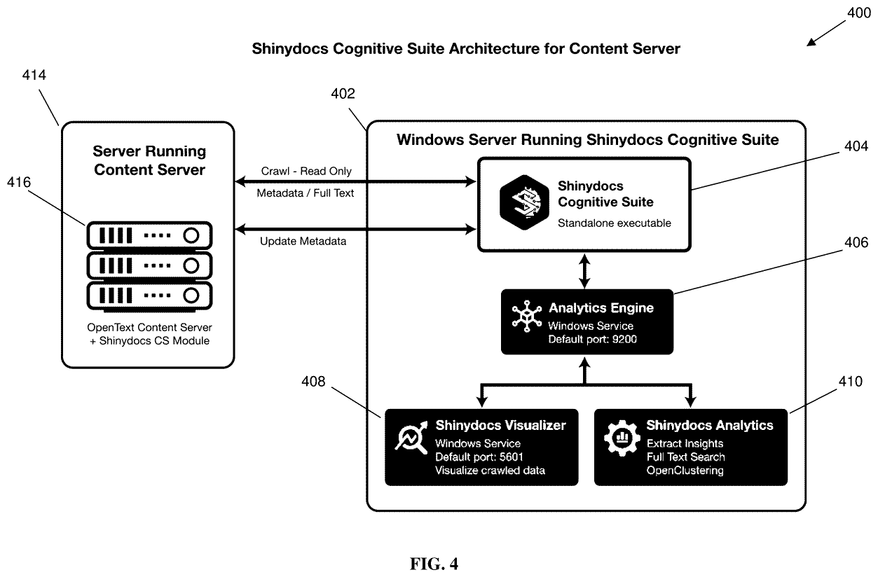

FIG. 4 is a schematic diagram illustrating architecture for content server. According to FIG. 4, one or more servers running Contest Server 414 is shown running OpenText Content Server and Shinydocs Content Server Module 416. One or more servers running Contest Server 414 interacts with a Windows Server running Shinydocs Cognitive Suite 402. The OpenText Content Server and Shinydocs Content Server Module 416, or Enterprise Content Management systems, content sources or file shares contain files of various sizes, many of which contain text.

According to FIG. 4, the Shinydocs Cognitive Suite 404 (as a component of Windows Server running Shinydocs Cognitive Suite 402) can be a standalone executable that extracts metadata from these file shares which are stored in the Analytics Engine 406. The Shinydocs Cognitive Suite 404 likewise extracts text from files in these file shares, which are also stored in the Analytics Engine 406.

According to FIG. 4, Analytics Engine 406 can programmatically break apart large chunks of text when doing text extraction and will likewise logically recombine those large chunks of text for operations such as searching for strings of text that are contained in the extracted text.

The Analytics Engine 406 described in FIG. 4 is part of the Shinydocs Cognitive Suite 402 and interfaces with the Shinydocs Visualizer 408 and Shinydocs Analytics 410 components (or modules). The Shinydocs Visualizer module 408 enables visualization of crawled data and enables a windows service to connect to a default port (e.g., port 5601). The Shinydocs Analytics module 410 is configured to extract insights, perform full text searches and perform open clustering.

According to FIG. 4, the Analytics Engine 406 also leverages open-source search applications (such as Elasticsearch or Open Search) as the underlying technology. In this description, Elasticsearch is referenced as the search engine, but is interchangeable with other similar open-source search engines. Furthermore, Analytics Engine 406 is also configured as a Windows Service enabling connection to a default port (e.g., port 9200).

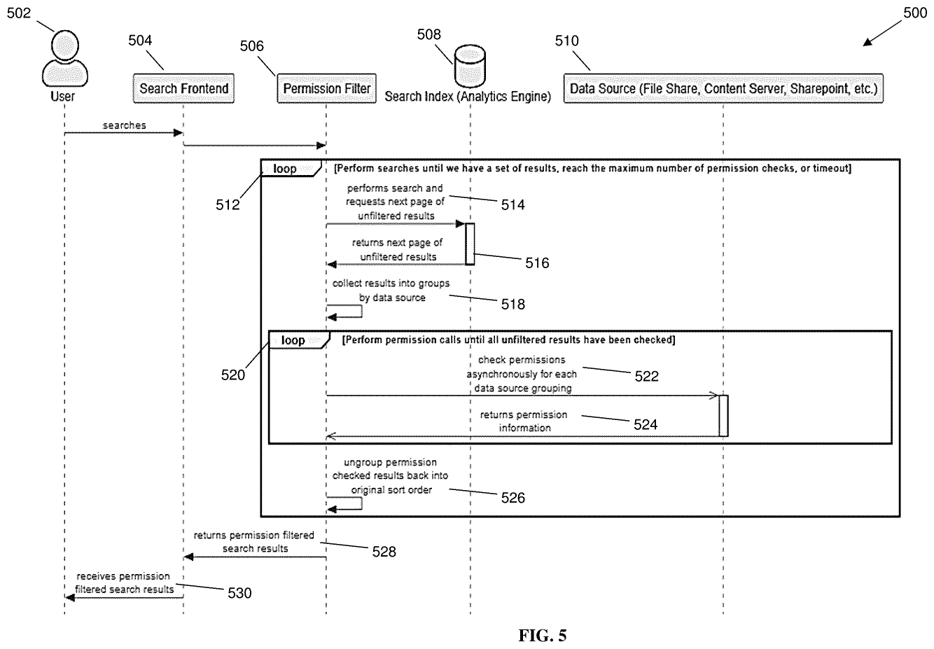

FIG. 5 is a flow diagram illustrating a dynamic search result permission checking process. According to FIG. 5, flow diagram 500 initiates with user 502 conducting a search with the Discovery Search Frontend (i.e., graphical user interface or GUI) at step 504. A request for permission filter is requested at step 506. The system will then check with the search index at step 508 of the Analytics Engine and retrieve results from the associated data source 510 (e.g., Content Server, SharePoint, etc.,).

According to FIG. 5, an iterative loop at step 512 will be conducted until the maximum number of permission checks is reached and all associated data sources referenced. Within the iterative loop at step 512, the system will perform a search and request the next page of unfiltered results at step 514 and return this to the user at step 516. Results are collected into groups by the data source at step 518.

According to FIG. 5, further iterative loops at step 520 will be conducted until all the unfiltered results have been checked, whereby the system asynchronously checks permissions for each group against the appropriate data source at step 522 and returns the permission information at step 524. The system will also ungroup permission-checked results back into the original sort order at step 526.

According to FIG. 5, upon completion of the iterative loops, the system returns permission-filtered search results to the Discovery Search Frontend at step 528. Finally, these permission-filtered search results are then displayed to the user at step 530.

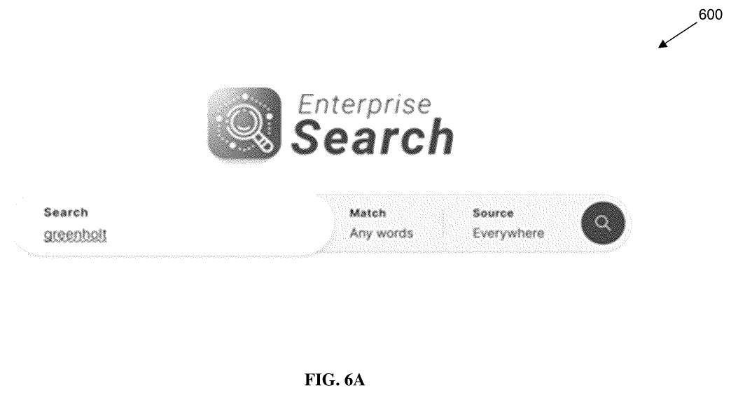

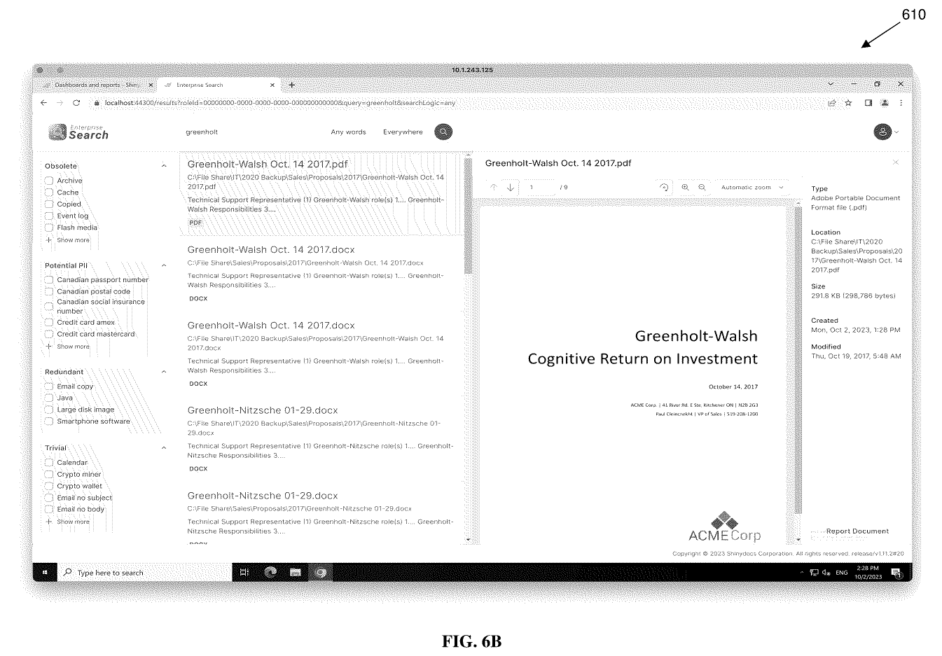

FIGS. 6A and 6B are exemplary embodiments of a Discover Search Frontend Graphical User Interface (GUI). According to FIG. 6A, a search Frontend Graphical User Interface (GUI) 600 is shown consistent with initiating a search at step 504 by the user 502 in FIG. 5. Upon executing the workflow 500 of FIG. 5, the resultant results will be provided to the user at step 530. An exemplary representation of the Discover Search GUI search results is shown in 610 of FIG. 6B.

The operation to crawl repositories and add information to the Shinydocs Index (or Indexes—typically one Index is created per source repository), is usually done with Administrator permissions. When a named end-user searches against these Indexes, a method is needed to “filter” out the resulting documents so that only those that the named end-user is permissioned to view are listed in the search results. This searching is done via the Shinydocs Discovery Search product. This invention is the creation of a dynamic method for checking document permissions before displaying search results in Discovery Search. Discovery Search has the ability to perform a search (and display results) across many Indexes at the same time.

This disclosure is designed to support the live “mapping” and on-demand validation of performant document permissions found on file shares, ECMs (Enterprise Content Management Systems) such as Microsoft SharePoint Online, IBM Filenet, OpenText Content Server, BOX, or even in email platforms like Microsoft Exchange (where documents exist as attachments).

The disclosure is as follows:
When a search is initiated in Discovery Search, an ongoing process first verifies that the query is valid—namely that:
   The requesting User is valid (via checking Active Directory)
   The Index or Indexes being searched are valid,
   The Roles assigned to that User are known,
   The Search query syntax is valid in accordance with the search engine functionality.
Assuming the above validity checks are OK, a search (or sequence of searches) is performed using Administrator rights against the requested Shinydocs Indexes.
After a set number of results are obtained (typically about 1,000), they are then filtered for the named end-user (via impersonation), by doing permission checks on each result that was returned against the known repository source of that result. Note that by this method, many search results may be initially returned, yet only a few of these may actually be valid for the named end-user to view.
   Example: If a search for “financial statements” returns 1,000 hits but the named end-user only has “read” permissions on 100 of these documents, ultimately 900 of these will be filtered out, generating the 100 hits that the named end-user is able to view.
Depending on the repository involved, such permission checks may be done via a proxy method (as is done for searches against Microsoft SharePoint Online).
   Example: If the search for “financial statements” was done against a File Share that had 1,000 individual hits, the permissions on each of those 1,000 items would be checked individually (via impersonation). Likewise, if SharePoint Online was included as a repository and it had 400 individual hits, this would normally result in 400 individual permission checks—one for each item (which can result in SharePoint possibly detecting this as a Denial of Service (DoS) attack and shutting down the connection). Instead, a bulk search is executed using the SharePoint Online search API for the SharePoint Online unique ids of the documents. The Discovery Search administrator can configure how many results are checked against SharePoint Online in each request, and the software will execute multiple bulk requests, aggregating the check of the established number of search results. As an example, if 400 search results need to be checked, and the number in any given bulk request is limited to 50, 8 requests will be made to SharePoint Online to check all the results. Any results returned from SharePoint Online indicate the documents to which the user has permissioned access. These results are matched up to the Discovery Search results and a filtered list of results are shown to the end user. Any other results that do not match up to the SharePoint Online results are not shown to the end user, since there is no evidence of permissioned access. Making a bulk permission request has significant performance benefits since fewer API requests are sent to SharePoint Online, also minimizing the possibility of SharePoint Online detecting a DoS attack.
For searches against an OpenText Content Server repository, the permission checks are performed in bulk, in a similar fashion to the proxy method described above. Shinydocs has developed a custom Content Server “module” that is able to take incoming compressed queries and expand them “internally” on Content Server, rather than having to perform a permission check on each individual item, one at a time.
   Example: If the search for “financial statements” was done against OpenText's Content Server, this might normally result in 500 individual permission checks on each of those items. Instead, such calls are sent in “bulk”, performing checks on a virtually unlimited number of items at a time (the request is sent via HTTP Post
      the actual limit depends on the server's resources and could be as large as 4 GB in the request), impersonating the named end-user. Content Server returns this result list, which is integrated into Discovery Search, thereby filtering the results to only display those items that the user is permissioned to see. This has significant performance benefits vs. doing each of these permission checks individually.
Additionally, for searches against a Content Server repository, there have also been implemented performance improvements in instances where OpenText Directory Services (OTDS) is involved. In this scenario, each permission check against Content Server needs to perform “handshaking” with OTDS in order to get a token before each permission check. The improvement made here is to cache the OTDS token so that it could be re-used for such permission checks until the token was considered invalid (which occurs after a set number of minutes). Once the token is invalid, an operation re-authenticates as the named end-user and obtains a new OTDS token, which is then cached and used again.
To further optimize these permission check queries against a source File Share or Content Server, the requesting user's credentials are first being checked against those of the source containing folder. In the event the user doesn't have access to a particular folder, it is known that user doesn't have access to any of the files in the folder, so there is no need to check permissions on any files contained within that folder. As a result, this step can save multiple individual file permission validation requests.

According to the disclosure, a computer-implemented method of dynamic search result permission checking on data of an enterprise content management system having an Analytics Engine is disclosed. The method comprising the steps of providing a computer processor, configuring the processor to couple with a network interface. The method further comprising the steps of configuring the processor, by a set of executable instructions storable in a memory to receive search instructions from a user from a Discovery Search Frontend (i.e., graphical user interface), send a request for a permission filter to the system, check a search index of the Analytics Engine of the system and retrieve results from one or more associated data sources (e.g., Content Server, SharePoint, etc.,), perform a search until an end condition is met, perform one or more permission calls until all unfiltered results have been checked, returning permission-filtered search results to Discovery Search Frontend (i.e., a graphical user interface) and displaying the filtered search results to the user.

According to the disclosure, the method is configured to search an index (i.e., Shinydocs Index) built from content from one or multiple source repositories, and only display results for which the user has sufficient permissions at source to view. The end condition further comprises returning a set of results, reaching the maximum number of permission checks or a timeout.

According to the disclosure, returning the set of results of the method further comprises requesting the next page of unfiltered results and returning this to the user. The step of perform one or more permission calls until all unfiltered results have been checked further comprises the system asynchronously checking permissions for each group against the appropriate data source and returning the permission information.

According to the disclosure, the method further comprising the step of ungrouping permission-checked results back into the original sort order. The user credentials of the method are validated “on the fly”, such that these checks are performant across a multiple of possible back-end repositories sequentially or simultaneously.

According to the disclosure, the resultant search results from the Index are sourced from many disparate repositories, the repositories having unique permission structures to view individual items. The handling permissions in multiple repositories of the method is done in a secure and performant fashion in order to only display search results that the end-user is allowed to view based on source system permissions.

According to the disclosure, a dynamic search result permission checking system configured for permission checking on data of an enterprise content management system is disclosed. The system comprising a computer processor, one or more file shares of the content management system configured to store one or more original documents, a content management system module configured to communicate with the file share of the content management system, an analytics module, a visualizer module configured to provide output and visualization of crawled data.

According to the disclosure, the system further comprises an analytics engine, in communication with the content management system module and the visualizer and analytics modules, the analytics engine configured to receive search instructions from a user from a Discovery Search Frontend (i.e., a graphical user interface), send a request for a permission filter to the system, check a search index of the Analytics Engine of the system and retrieve results from one or more associated data source (e.g., Content Server, SharePoint, etc.), perform a search until an end condition is met, perform one or more permission calls until all unfiltered results have been checked, return permission-filtered search results to Discovery Search Frontend (GUI), display the filtered search results to the user. The system is configured to search an index (i.e., Shinydocs Index) built from content from one or multiple source repositories, and only display results for which the user has sufficient permissions at source to view.

According to the disclosure, the end condition of the system further comprises returning a set of results, reaching the maximum number of permission checks or a timeout. Returning the set of results of the system further comprises requesting the next page of unfiltered results and returning this to the user. The system further comprising the step of performing one or more permission calls until all unfiltered results have been checked further comprising the system asynchronously checking permissions for each group against the appropriate data source and returning the permission information.

According to the disclosure, the step of ungrouping permission-checked of the system results back into the original sort order. The user credentials of the system are validated “on the fly”, such that these checks are performant across a multiple of possible back-end repositories sequentially or simultaneously.

According to the disclosure, the resultant search results from the Index of the system are sourced from disparate repositories, the repositories having unique permission structures to view individual items. The step of handling permissions in multiple repositories of the system is in a secure and performant fashion in order to only display search results that the end-user is allowed to view based on source system permissions.

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented method of dynamic search result permission checking on data of an enterprise content management system having an Analytics Engine, the method comprising the steps:
providing a computer processor;
configuring the processor to couple with a network interface;
configuring the processor, by a set of executable instructions storable in a memory, configured to:
receiving search instructions from a user from a Discovery Search Frontend;
sending a request for a permission filter to the system;
checking a search index of the Analytics Engine of the system and retrieve results from one or more associated data sources;
performing a search until an end condition is met;
performing one or more permission calls until all unfiltered results have been checked;
returning permission-filtered search results to Discovery Search Frontend;
displaying the filtered search results to the user;
wherein the method is configured to search an index built from content from one or multiple source repositories, and only display results for which the user has sufficient permissions at source to view.

2. The method of claim 1 wherein the end condition further comprises returning a set of results, reaching the maximum number of permission checks or a timeout.

3. The method of claim 1 wherein returning the set of results further comprises requesting the next page of unfiltered results and returning this to the user.

4. The method of claim 1 wherein the step of perform one or more permission calls until all unfiltered results have been checked further comprises the system asynchronously checking permissions for each group against the appropriate data source and returning the permission information.

5. The method of claim 4 further comprising the step of ungrouping permission-checked results back into the original sort order.

6. The method of claim 1 wherein the user credentials are validated “on the fly”, such that these checks are performant across a multiple of possible back-end repositories sequentially or simultaneously.

7. The method of claim 1 wherein the resultant search results from the Index are sourced from many disparate repositories, the repositories having unique permission structures to view individual items.

8. The method of claim 1 wherein the handling permissions in multiple repositories is done in a secure and performant fashion in order to only display search results that the end-user is allowed to view based on source system permissions.

9. The method of claim 1 wherein the Discovery Search Frontend is a graphical user interface (GUI).

10. A dynamic search result permission checking system configured for permission checking on data of an enterprise content management system, the system comprising:
a computer processor;
one or more file shares of the content management system configured to store one or more original documents;
a content management system module configured to communicate with the file share of the content management system;
an analytics module;
a visualizer module configured to provide output and visualization of crawled data; and
an analytics engine, in communication with the content management system module and the visualizer and analytics modules, the analytics engine configured to:
receive search instructions from a user from a Discovery Search Frontend;
send a request for a permission filter to the system;
check a search index of the Analytics Engine of the system and retrieve results from one or more associated data source;
perform a search until an end condition is met;
perform one or more permission calls until all unfiltered results have been checked;
return permission-filtered search results to Discovery Search Frontend;
display the filtered search results to the user;
wherein the system is configured to search an index built from content from one or multiple source repositories, and only display results for which the user has sufficient permissions at source to view.

11. The system of claim 10 wherein the end condition further comprises returning a set of results, reaching the maximum number of permission checks or a timeout.

12. The system of claim 10 wherein returning the set of results further comprises requesting the next page of unfiltered results and returning this to the user.

13. The system of claim 10 further comprising the step of performing one or more permission calls until all unfiltered results have been checked further comprising the system asynchronously checking permissions for each group against the appropriate data source and returning the permission information.

14. The system of claim 10 further comprising the step of ungrouping permission-checked results back into the original sort order.

15. The system of claim 10 wherein the user credentials are validated “on the fly”, such that these checks are performant across a multiple of possible back-end repositories sequentially or simultaneously.

16. The system of claim 10 wherein the resultant search results from the Index are sourced from disparate repositories, the repositories having unique permission structures to view individual items.

17. The system of claim 10 further comprising the step of handling permissions in multiple repositories in a secure and performant fashion in order to only display search results that the end-user is allowed to view based on source system permissions.

18. The system of claim 10 wherein the Discovery Search Frontend is a graphical user interface (GUI).
